(19) United States
(12) Patent Application Publication
(10) Pub. No.: US 2026/0155320 A1
(43) Pub. Date: Jun. 4, 2026

(54) RAPID-CLICK SWITCH

(71) Applicant: SHENZHEN DRUNKEN DEER TECHNOLOGY CO., LTD., SHENZHEN (CN)

(72) Inventors: RUI LI, SHENZHEN (CN); JIE XIANG, HUIZHOU (CN); XULONG HUANG, HUIZHOU (CN); JIANPING LI, HUIZHOU (CN); HAIHUI HUANG, HUIZHOU (CN)

(21) Appl. No.: 19/457,087

(22) Filed: Jan. 22, 2026

(30) Foreign Application Priority Data
Nov. 11, 2025 (CN) 202511645852.0

(51) Int. Cl. H01H 3/26; H01H 3/12; H01H 3/22; H01H 3/42

(52) U.S. Cl. CPC H01H 3/26; H01H 3/12; H01H 3/227; H01H 3/42; H01H 2003/266

(57) ABSTRACT

A rapid-click switch includes a button switch, at least one triggering component, an active reset mechanism, and a control module. When the button switch is pressed, the at least one triggering component is switched on and then deactivated to trigger the control module, and the control module controls the active reset mechanism to drive the button switch to rapidly return to an initial position before being pressed.

### TECHNICAL FIELD

The present disclosure relates to a field of mechanical switches, and in particular to a rapid-click switch that assists a user in rapidly clicking.

### BACKGROUND

button switches (such as micro switches, keyboard switches, etc.) are important components for user interaction with electronic devices and are widely used in scenarios such as remote controls, game controllers, keyboards, and industrial control panels. The micro switches are a main type of button switches, commonly found in electronic products such as mice.

Micro clicking switches belong to a category of conventional short-travel button switches, and an operation thereof relies on the user pressing and releasing the button switch with their fingers to trigger a response. The micro clicking switches typically incorporate internal spring or reed structures, allowing a button switch in the micro clicking switches to move up and down, thereby activating internal electronic components to generate corresponding signal outputs. However, such a finger-clicking method shows significant limitations when facing certain demands for high-speed continuous clicking, such as rapid operations in video games. Users not only find it difficult to sustain high-speed clicking over extended periods but are also highly prone to finger fatigue and may even experience discomfort or injury to muscles or joints, even if the users manage to perform such actions temporarily.

### SUMMARY

To address aforementioned problems, the present disclosure aims to provide an auxiliary device that assists a user in rapidly clicking a switch button, allowing the user to achieve rapid clicking of the switch button simply by pressing (without fully lifting the finger).

To achieve the above object, the present disclosure provides a rapid-click switch. The rapid-click switch comprises a button switch, at least one triggering component, an active reset mechanism, and a control module. When the button switch is pressed, the at least one triggering component is switched on and then deactivated to trigger the control module, and the control module controls the active reset mechanism to drive the button switch to rapidly return to an initial position before being pressed.

In one optional embodiment, the active reset mechanism comprises a motor and a transmission mechanism. The transmission mechanism rapidly resets the button switch to the initial position in one working cycle and then runs to an initial state. The motor is controlled by the control module, and the motor drives the transmission mechanism to complete the working cycle during operation.

In one optional embodiment, the transmission mechanism comprises a cam. When the cam is in the initial state, a portion of the cam closest to a rotation axis is close to the button switch.

In one optional embodiment, the control module comprises a detection unit for detecting on and off of the button switch and a control unit for controlling the active reset mechanism.

In one optional embodiment, the active reset mechanism is connected in parallel with the button switch. When the button switch is activated, the active reset mechanism is short-circuited. When the button switch is deactivated, the active reset mechanism is powered on to work.

In one optional embodiment, the active reset mechanism further comprises a delay start circuit, and the active reset mechanism starts to work only after the button switch is deactivated for a predetermined duration.

In one optional embodiment, the control module comprises a start signal generation unit and a stop signal generation unit. The button switch comprises a first triggering member configured to trigger the start signal generation unit. The active reset mechanism comprises a second triggering member configured to trigger the stop signal generation unit. When the button switch is pressed downward, the first triggering member triggers the start signal generation unit to generate a start signal to start the active reset mechanism, so that the active reset mechanism starts an action from an initial state. When the active reset mechanism returns to the initial state, the second triggering member triggers the stop signal generation unit to generate a stop signal to stop the active reset mechanism.

In one optional embodiment, the first triggering member is a magnetic element. The start signal generation unit is a Hall sensor. The magnetic element is driven to trigger the Hall sensor to generate the start signal to start the active reset mechanism when the button switch is pressed downward.

In one optional embodiment, the second triggering member is a grating component. The stop signal generation unit is an optical sensor pair composed of a light-emitting element and a light-receiving element. The active reset mechanism works such that the grating component affects an optical path between the light-emitting element and the light-receiving element, and the light-receiving element generates the stop signal to stop the active reset mechanism.

In one optional embodiment, the cam is an eccentric wheel.

When a user releases the button switch, the active reset mechanism gently lifts a finger of the user under an external force, causing a rapid upward reset of the button switch without requiring the user to fully lift their finger. Therefore, the user only needs to continuously press and hold the button switch to achieve rapid up-and-down movement, resulting in a high-speed clicking effect when controlling a display screen through the rapid-clicking switch. The rapid up-and-down movement of the button switch achieves a clicking speed of the user far exceeding that of a normal hand click. A structure of the rapid-click switch further reduces finger fatigue and provides a satisfying tactile feedback for rapid clicking.

### BRIEF DESCRIPTION OF DRAWINGS

FIG. 1 is a schematic diagram of a rapid-clicking switch according to one embodiment of the present disclosure.

FIG. 2 is a circuit diagram of embodiment 1 of the rapid-click switch of the present disclosure.

FIG. 3 is a circuit diagram of embodiment 2 of the rapid-click switch of the present disclosure.

FIG. 4 is an exploded schematic diagram of the rapid-clicking switch according to one embodiment of the present disclosure.

FIG. 5 is a cross-sectional schematic diagram of the rapid-clicking switch according to one embodiment of the present disclosure.

FIG. 6 is a schematic diagram of the rapid-clicking switch according to one embodiment of the present disclosure, where a pressing shaft block is in an initial position,

FIG. 7 is a schematic diagram of the rapid-clicking switch according to one embodiment of the present disclosure, where the pressing shaft block is pressed down.

FIG. 8 is a schematic diagram of a driving mechanism of the rapid-clicking switch according to one embodiment of the present disclosure.

### DETAILED DESCRIPTION

With reference to the embodiments and accompanying drawings, the present disclosure is further described in detail below.

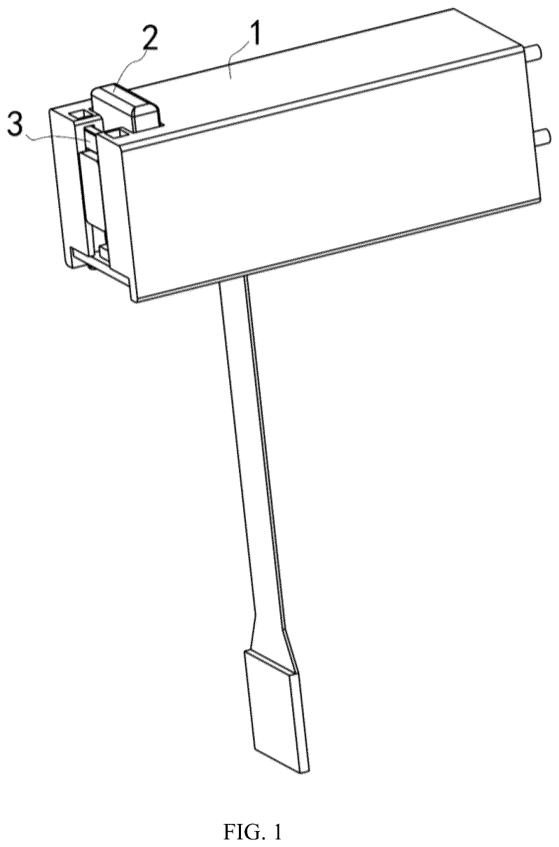

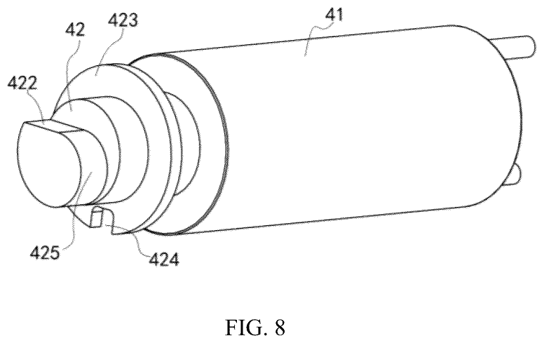

In the embodiment, a rapid-click switch is provided. As shown in FIGS. 1-8, the rapid-click switch comprises a housing 1 and a button switch 2. The button switch 2 is movably mounted to the housing 1 in a vertical direction. A top portion of the button switch extends out of the housing 1 for being pressed by a user. The rapid-click switch further comprises an active reset mechanism 4 and a control module 5. A triggering component corresponding to the button switch are disposed on the control module 5. In the embodiment, when a finger of the user presses the button switch 2 downward from an initial position by a certain stroke, a magnetic element 21 disposed inside the button switch 2 triggers a Hall sensor 51 (the triggering component), thereby generating a start signal (in other embodiments, the button switch 2 may be a mechanical button switch that directly connects two contacts.) The start signal is configured to generate an operational output of the rapid-click switch. When the finger leaves the button switch 2, in the embodiment, a magnet above the housing attracts the magnetic element 21, causing the button switch 2 to move away from the Hall sensor 51 (in other embodiments, the button switch is reset by a return spring). At this point, the control module 5 generates a disconnection signal, and the disconnection signal from the control module 5 controls the active reset mechanism 4 to start operating (e.g., rotating), thereby driving the button switch 2 to rapidly return to the initial position. Afterward, the active reset mechanism 4 returns to an initial state. When the finger of the user leaves the rapid-click switch, the active reset mechanism 4 lifts the finger smoothly under an external force, eliminating a need for the user to fully lift their finger to achieve rapid upward reset of the button switch 2. As a result, the user only needs to keep their finger continuously pressing the button switch to achieve rapid up-and-down movement of the button switch, enabling high-speed clicking operations. Each click driven by the active reset mechanism 4 to rapidly reset the button switch 2 takes only 1/5 to 1/3 of a duration required for a conventional button switch (which relies on magnetic attraction or spring resetting) where the user must fully lift their finger. The button switch 2 is enabled to move up and down rapidly, achieving a fast-clicking effect far exceeding manual speed. With such configurations, the finger of the user is less prone to fatigue and the user is able to experience the tactile feedback of rapid clicking.

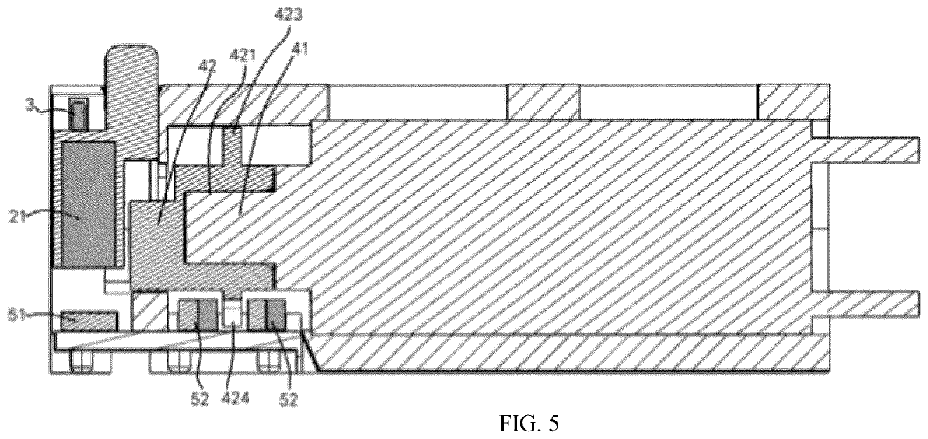

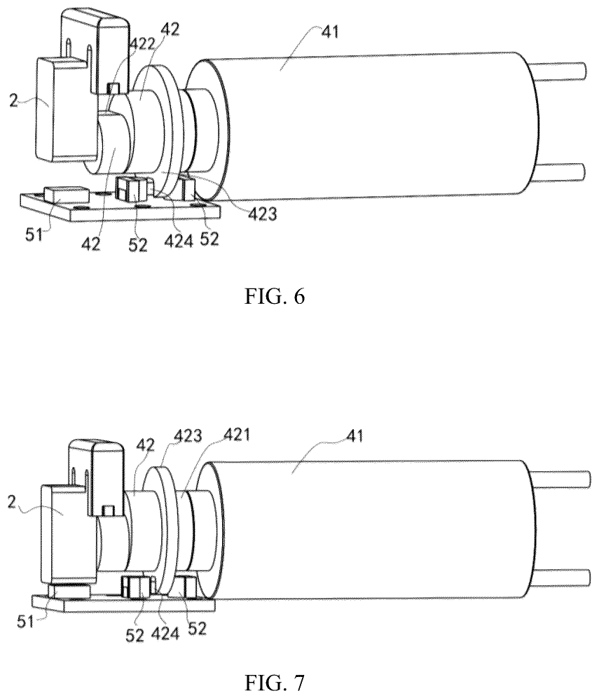

Furthermore, in the embodiment of the rapid-click switch, as shown in FIGS. 4-7, the active reset mechanism 4 comprises a motor 41 and a cam 42 driven by the motor 41. When the active reset mechanism 4 is in the initial state, the cam 42 is oriented such that the portion of the cam closest to its own rotation axis faces the button switch 2. A closest position 422 of the cam 42 to a rotation axis of the cam 42 faces the button switch 2 and is defined as an initial position of the active reset mechanism 4 in the initial state. In this way, when the button switch 2 and the active reset mechanism 4 are in their initial positions, there is sufficient space between the button switch 2 and the cam 42 to allow the button switch 2 to move downward. As shown in FIGS. 5 and 6, when the button switch 2 is pressed downward by the finger to a position where the button switch 2 triggers a start signal generation unit to generate the start signal, the motor 41 is instructed to rotate, driving the cam 42 to rotate. At this point, the cam 42 abuts against the button switch 2, thereby lifting the button switch upward rapidly to reset the button switch.

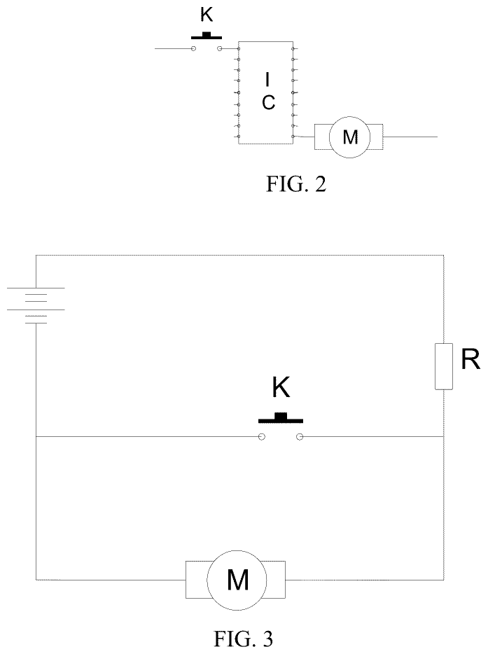

In Embodiment 1 of the rapid-click switch, the control module 5 comprises software within a control chip. As shown in FIG. 2, the control module 5 comprises a detection unit connected to an integrated circuit (IC) input port and a control unit. The IC input port is configured to detect whether the button switch is activated, and the control unit is connected to an IC output port for controlling the active reset mechanism (especially the motor).

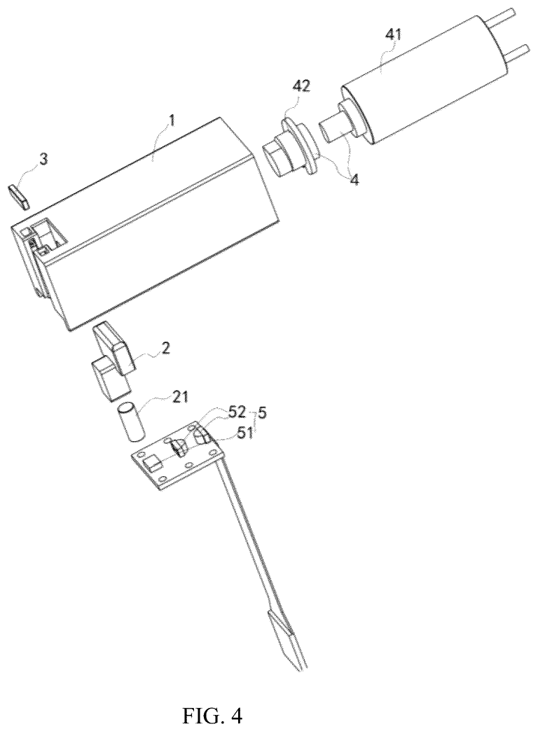

In Embodiment 2 of the rapid-click switch, the control module 5 comprises a circuit structure. As shown in FIG. 3, the active reset mechanism 4 is connected in parallel with the button switch 2. When the button switch 2 is activated, the active reset mechanism 4 is short-circuited. When the button switch 2 is deactivated, the active reset mechanism 4 is powered on to lift the button switch 2 upward.

Furthermore, in the embodiment of the rapid-click switch, to prevent erroneous operations caused by abnormal finger tremors, the active reset mechanism 4 further comprises a delay start circuit. The active reset mechanism 4 starts to work only after the button switch is deactivated for a predetermined duration, thereby avoiding improper lifting of the button switch by the active reset mechanism due to abnormal finger tremors.

Furthermore, in the embodiment of the rapid-click switch, to maintain the button switch 2 in the initial position thereof when no external force is applied (as shown in FIG. 5, where a top end of the button switch 2 extends out of the housing 1), it is necessary to provide a retaining piece 3 to prevent the button switch 2 from sliding downward under its own gravity and triggering the control module, thereby avoiding unintended activation. In specific implementations, the retaining piece 3 may be an elastic piece or any other structural part or element capable of preventing the button switch from moving downward without being pressed. Furthermore, to guide and limit the up-and-down movement of the button switch 2, at least one guide groove is defined in the housing 1, and the button switch 2 is slidbly disposed in the at least one guide groove of the housing 1 in the vertical direction. Optionally, the at least one guide groove comprises one guide groove or two guide grooves disposed in parallel.

Furthermore, in the embodiment of the rapid-click switch, as shown in FIGS. 4-5, the magnetic element 21 (typically a permanent magnet) is mounted on the button switch 2. Correspondingly, the start signal generation unit is the Hall sensor 51. When the button switch 2 moves downward, the magnetic element 21 triggers the Hall sensor 51 to generate the start signal, which is configured to cause the motor 41 to start rotating. Precisely because of an introduction of the magnetic element 21, in one optimal implementation, the retaining piece 3 is ingeniously designed as a magnet or a magnetically conductive block that is able to attract the magnetic element 21. The magnet or the magnetically conductive block, serving as the retaining piece 3, is mounted in the housing 1 above the magnetic element 21 of the button switch 2. By the magnetic attraction between the retaining piece 3 and the magnetic element 21, the button switch 2 is maintained in the initial position thereof when not pressed by the user.

Furthermore, in the embodiment of the rapid-click switch, a detection element is further introduced to detect a position of the motor. As shown in FIG. 4-5, the cam 42 is coaxially connected to a grating component and driven to rotate by the motor 41. The stop signal generation unit is an optical sensor pair 52 composed of a light-emitting element and a light-receiving element. A path where light emitted by the light-emitting element and light received by the light-receiving element transmit is referred to as an optical path. During operation, when the grating component rotates together with the motor 41 to a position where the grating component interrupts the optical path between the light-emitting element and the light-receiving element, the light-receiving element generates the stop signal due to a change in received light. The stop signal is configured to cause the motor 41 to stop rotating.

Furthermore, in the embodiment of the rapid-click switch, the grating component has two implementations. As shown in FIGS. 6-8, in one embodiment, the grating component is an opaque ring-shaped disk 423. The ring-shaped disk 423 comprises a light-passing hole. The light-emitting element and the light-receiving element are respectively disposed on two sides of the ring-shaped disk 423. The light from the light-emitting element is blocked by the ring-shaped disk. When the motor 41 is activated to drive the cam 42 to rotate back to the initial state/position, the light-passing hole 424 on the ring-shaped disk 423 is precisely located between the light-emitting element and the light-receiving element. At this point, the light-receiving element receives the light emitted by the light-emitting element and generates the stop signal, and the stop signal then commands the motor 41 to stop rotating.

In another embodiment, the grating component is a light-blocking block (not shown in the figures). The light-emitting element and the light-receiving element are respectively disposed on two sides of the light-blocking block, and the light-receiving element is able to receive the light emitted by the light-emitting element. When the motor 41 is activated to drive the cam 42 to rotate back to the initial state/position, the light-blocking block is precisely located between the light-emitting element and the light-receiving element. At this point, the light-receiving element is unable to receive the light emitted by the light-emitting element, and thus generates the stop signal.

The stop signal commands the motor 41 to stop rotating.
The above describes the rapid-click switch of the present disclosure to help understand the present disclosure. However, the implementation of the present disclosure is not limited to the above embodiments. Any changes, modifications, substitutions, combinations, or simplifications made without departing from the principle of the present disclosure should be considered equivalent substitutions and are comprised within the protection scope of the present disclosure.

What is claimed is:

1. A rapid-click switch, comprising:
a button switch;
at least one triggering component;
an active reset mechanism; and
a control module;
wherein when the button switch is pressed, the at least one triggering component is activated and then deactivated to trigger the control module, and the control module controls the active reset mechanism to drive the button switch to rapidly return to an initial position before being pressed.

2. The rapid-click switch according to claim 1, wherein the active reset mechanism comprises a motor and a transmission mechanism;
wherein the transmission mechanism rapidly resets the button switch to the initial position in one working cycle and then returns to an initial state, the motor is controlled by the control module, and the motor drives the transmission mechanism to complete the working cycle during operation.

3. The rapid-click switch according to claim 2, wherein the transmission mechanism comprises a cam, and when the cam is in the initial state, a portion of the cam closest to a rotation axis is close to the button switch.

4. The rapid-click switch according to claim 1, wherein the control module comprises a detection unit for detecting on and off of the button switch and a control unit for controlling the active reset mechanism.

5. The rapid-click switch according to claim 1, wherein the active reset mechanism is connected in parallel with the button switch, when the button switch is activated, the active reset mechanism is short-circuited, and when the button switch is deactivated, the active reset mechanism is powered on to work.

6. The rapid-click switch according to claim 1, wherein the active reset mechanism further comprises a delay start circuit, and the active reset mechanism starts to work only after the button switch is deactivated for a predetermined duration.

7. The rapid-click switch according to claim 1, wherein the control module comprises a start signal generation unit and a stop signal generation unit, the button switch comprises a first triggering member configured to trigger the start signal generation unit, and the active reset mechanism comprises a second triggering member configured to trigger the stop signal generation unit;
wherein when the button switch is pressed downward, the first triggering member triggers the start signal generation unit to generate a start signal to start the active reset mechanism, so that the active reset mechanism is activated from an initial state;
wherein when the active reset mechanism returns to the initial state, the second triggering member triggers the stop signal generation unit to generate a stop signal to stop the active reset mechanism.

8. The rapid-click switch according to claim 7, wherein the first triggering member is a magnetic element, the start signal generation unit is a Hall sensor, and the magnetic element is driven to trigger the Hall sensor to generate the start signal to start the active reset mechanism when the button switch is pressed downward.

9. The rapid-click switch according to claim 7, wherein the second triggering member is a grating component, the stop signal generation unit is an optical sensor pair composed of a light-emitting element and a light-receiving element, and the active reset mechanism works such that the grating component affects an optical path between the light-emitting element and the light-receiving element, and the light-receiving element generates the stop signal to stop the active reset mechanism.

10. The rapid-click switch according to claim 3, wherein the cam is an eccentric wheel.
